(19) United States
(12) Patent Application Publication
(10) Pub. No.: US 2026/0106388 A1
(43) Pub. Date: Apr. 16, 2026

(54) INHIBITOR RETENTION FEATURE FOR ELECTRICAL CONNECTION

(71) Applicant: TE Connectivity Solutions GmbH, Schaffhausen (CH)

(72) Inventors: Nathan Philip Myer, Middletown, PA (US); Marjorie Kay Myers, Middletown, PA (US); Michael Fulcher, Winston Salem, NC (US); Steven Nash, Winston Salem, NC (US); William Jackson, Winston Salem, NC (US)

(21) Appl. No.: 18/911,433

(22) Filed: Oct. 10, 2024

(51) Int. Cl. H01R 11/28; H01R 11/12

(52) U.S. Cl. CPC H01R 11/284; H01R 11/12; H01R 2201/26

(57) ABSTRACT

A conductor for an electrical connector includes a conductor body extending between a mating end and a terminating end. The conductor body includes a connecting surface at the mating end and/or the terminating end. The conductor for the electrical connector includes an inhibitor encapsulation element that includes a blocking wall extending from the connecting surface. The blocking wall forms an inhibitor well along the mating surface configured to be filled with corrosion inhibitor material. The blocking wall is configured to capture the corrosion inhibitor material in the inhibitor well on the mating surface.

### BACKGROUND OF THE INVENTION

The subject matter herein relates generally to electrical connectors.

Electrical connectors are used to electrically connect various components within a system. For example, electrical connectors are used in power systems to supply power between various components. The electrical connectors include conductors configured to be coupled to other components at a mating interface. For power connections, a reliable connection is needed between the electrical conductors. As such, some known connectors include bolted connections to create a reliable electrical connection between the conductors.

In some industries, such as the automotive industry, it may be desirable to replace copper conductors with aluminum conductors to reduce cost of components within the vehicle. A major challenge to overcome is connecting the aluminum conductors because aluminum forms a highly resistive, hard oxide layer hundred natural atmospheric conditions. It is difficult to achieve low resistance in a bolted connection without pretreatment, corrosion inhibitors, or plating of the components, which increase cost. For example, the application of corrosion inhibitors on the surfaces of the conductors may become a source of potential failure in the system as the corrosion inhibitors tend to migrate and dissipate over time. For example, the pressure applied at the interface from the bolted connection may cause the corrosion inhibitor material to be displaced from the interface, which may leave surfaces of the conductors exposed in the subject to oxidation.

A need remains for an electrical connector having corrosion inhibitor retention features that retain the corrosion inhibitor at the mating interface.

### BRIEF DESCRIPTION OF THE INVENTION

In one embodiment, a conductor for an electrical connector is provided and includes a conductor body extending between a mating end and a terminating end. The conductor body includes a connecting surface at the mating end and/or the terminating end. The conductor for the electrical connector includes an inhibitor encapsulation element that includes a blocking wall extending from the connecting surface. The blocking wall forms an inhibitor well along the mating surface configured to be filled with corrosion inhibitor material. The blocking wall is configured to capture the corrosion inhibitor material in the inhibitor well on the mating surface.

In another embodiment, a conductor for an electrical connector is provided and includes a conductor body extending between a mating end and a terminating end. The conductor body includes a mating surface at the mating end. The conductor for the electrical connector includes an inhibitor encapsulation element that includes blocking walls extending from the mating surface forming inhibitor wells along the mating surface. The blocking walls include an outer blocking wall forming an outer ring defining a mating area. The blocking walls include a nested blocking wall forming a nested ring embedded within the mating area and surrounded by the outer ring. The inhibitor wells configured to be filled with corrosion inhibitor material. The blocking walls are configured to capture the corrosion inhibitor material in the corresponding inhibitor wells on the mating surface.

In a further embodiment, an electrical connector is provided and includes a power cable having an end. The electrical connector includes a conductor that has a conductor body that extends between a mating end and a terminating end. The terminating end is terminated to the end of the power cable. The conductor body includes a mating surface at the mating end. The conductor includes an inhibitor encapsulation element includes a blocking wall extending from the mating surface. The blocking wall forming an inhibitor well along the mating surface configured to be filled with corrosion inhibitor material. The blocking wall configured to capture the corrosion inhibitor material in the inhibitor well on the mating surface.

### BRIEF DESCRIPTION OF THE DRAWINGS

FIG. 1 illustrates a portion of an electrical connector in accordance with an exemplary embodiment.

FIG. 2 is a perspective view of the conductor in accordance with an exemplary embodiment.

FIG. 3 is a cross-sectional view of the conductor showing a portion of the inhibitor encapsulation element in accordance with an exemplary embodiment.

FIG. 4 is a cross-sectional view of the conductor showing a portion of the inhibitor encapsulation element in accordance with an exemplary embodiment.

FIG. 5 is a perspective view of the conductor in accordance with an exemplary embodiment.

FIG. 6 is a perspective view of a charging inlet assembly in accordance with an exemplary embodiment that incorporates the electrical connector.

FIG. 7 is a perspective view of the electrical connector in accordance with an exemplary embodiment for use in the charging inlet assembly.

### DETAILED DESCRIPTION OF THE INVENTION

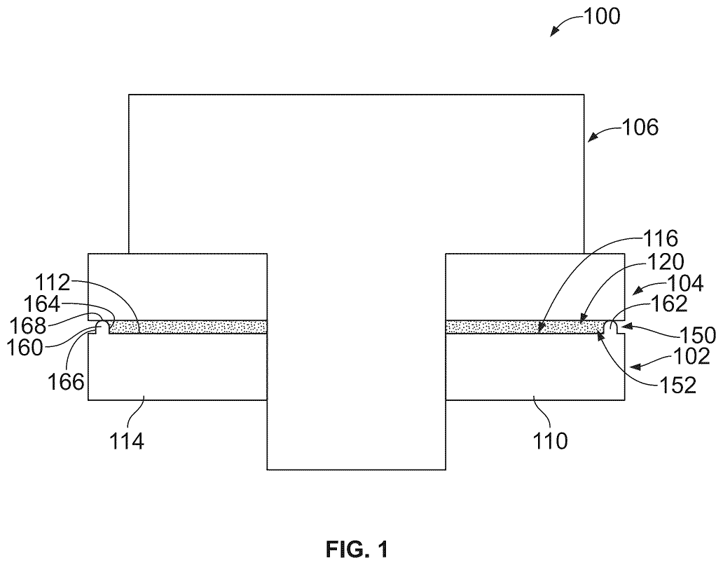

FIG. 1 illustrates a portion of an electrical connector 100 in accordance with an exemplary embodiment. The electrical connector 100 includes a conductor 102 configured to be electrically connected to a mating conductor 104. In an exemplary embodiment, the conductor 102 is coupled to the mating conductor 104 by a bolted connection using a bolt 106 passing through the conductor 102 in the mating conductor 104. The bolt 106 may be threadably coupled to the conductor 102 and/or the mating conductor 104. In other various embodiments, the bolt 106 may be secured using a nut threadably coupled to the end of the threaded shaft of the bolt 106.

The conductor 102 includes a conductor body 110. In an exemplary embodiment, the conductor body 110 is manufactured from a metal material, such as aluminum, an aluminum alloy, copper, a copper alloy, steel, or other metal material. The conductor body 110 may have opposite first and second surfaces 112, 114. For example, the first and second surfaces 112, 114 may be an upper surface and a lower surface, respectively. The first surface 112 faces the mating conductor 104 and includes a connecting surface 116, which is the portion of the first surface 112 configured to interface with the mating conductor 104. An electrical connection is made between the conductor 102 and the mating conductor 104 through the connecting surface 116. The connecting surface 116 may be a portion of the first surface 112 or the entire first surface 112 depending on the particular application and the size and shape of the mating conductor 104. The conductor 102 may be a busbar, a terminal, a plate, or other type of conductor. The conductor 102 may be terminated to an end of a wire or cable in various embodiments. The conductor 102 may be directly connected to electrical components at one or both ends of the conductor 102 in various embodiments.

In an exemplary embodiment, a corrosion inhibitor material 120 is applied to the surfaces of the conductor body 110 to reduce award inhibit corrosion of the conductor body 110. The corrosion inhibitor material 120 forms a protective layer on the surface of the conductor body 110, which prevents corrosive elements such as oxygen, water, salts, and the like from reaching and reacting with the metal surface of the conductor body 110. The corrosion inhibitor material 120 extends the lifespan of the metal material of the conductor body 110, reducing maintenance cost in preventing potential failures in the electrical connector 100. The corrosion inhibitor material 120 may be a non-petroleum based substance. The corrosion inhibitor material 120 may be compatible for use with insulating material such as rubber, polyethylene, and the like. The corrosion inhibitor material 120 may be suitable for use with high voltage applications. In various embodiments, the corrosion inhibitor material 120 is a synthetic silicone-based compound having zinc particles suspended in the compound, such as a Penetrox A-13 product or similar corrosion inhibitor material. In various embodiments, the corrosion inhibitor material 120 may be a viscoelastic substance, such as being in a gel or paste form. For example, the corrosion inhibitor material 120 may exhibit solid like properties capable of preserving shape in a steady-state, and unable to flow as a liquid in such steady state, but may undergo shape change in the presence of applied force.

In an exemplary embodiment, the conductor 102 includes one or more inhibitor encapsulation elements 150 used to capture or trap the corrosion inhibitor material 120. The inhibitor encapsulation elements 150 protrude from the connecting surface 116 to form a pocket or well 152 that holds the corrosion inhibitor material 120. The inhibitor encapsulation elements 150 prevents the corrosion inhibitor material 120 from being displaced and flowing out of the interface between the conductor 102 and the mating conductor 104 along the connecting surface 116 during assembly, such as during tightening of the bolt 106. The inhibitor encapsulation elements 150 may create an airtight enclosure at the interface between the conductor 102 and the mating conductor 104 when the parts are compressed together by the bolt 106 to trap the corrosion inhibitor material 120 at the interface between the parts. The inhibitor encapsulation elements 150 trap the corrosion inhibitor material 120 at the interface to prevent corrosion of the conductor body 110 in the mating area with the mating conductor 104. In various embodiments, the inhibitor encapsulation elements 150 may additionally or alternatively be applied to the mating conductor 104.

In an exemplary embodiment, the inhibitor encapsulation elements 150 includes one or more blocking walls 160 extending from the connecting surface 116. The blocking walls 160 may be formed by ribs 162, which are protrusions protruding outward (for example, upward) from the connecting surface 116. The blocking wall 160 includes an interior surface 164, an exterior surface 166, and a distal edge 168 at the tip of the blocking wall 160. The interior and exterior surfaces 164, 166 extend from the connecting surface 116 to the distal edge 168. The blocking wall 160 forms the inhibitor well 152. The inhibitor well 152 receives the corrosion inhibitor material 120. For example, the corrosion inhibitor material 120 may fill the inhibitor well 152 along the connecting surface 116 between the interior surfaces 164 of the blocking walls 160. For example, the corrosion inhibitor material 120 may fill the space interior of or between the rib(s) 162.

In various embodiments, the ribs 162 may be compressed or crushed during assembly when the bolt 106 is tightened. Such compression or crushing may wipe or scrape the mating conductor 104 during mating, which breaks through any oxides (for example, aluminum oxide) on the underside of the mating conductor 104. The wiping action exposes the base metal material of the mating conductor 104 to form a low resistance electrical connection between the conductor 102 and the mating conductor 104. The corrosion inhibitor material 120 may coat the interface between the conductor 102 and the mating conductor 104 to prevent corrosion at the interface to extend the lifespan of the metal components, which reduces maintenance costs and prevents potential failures of the electrical connection.

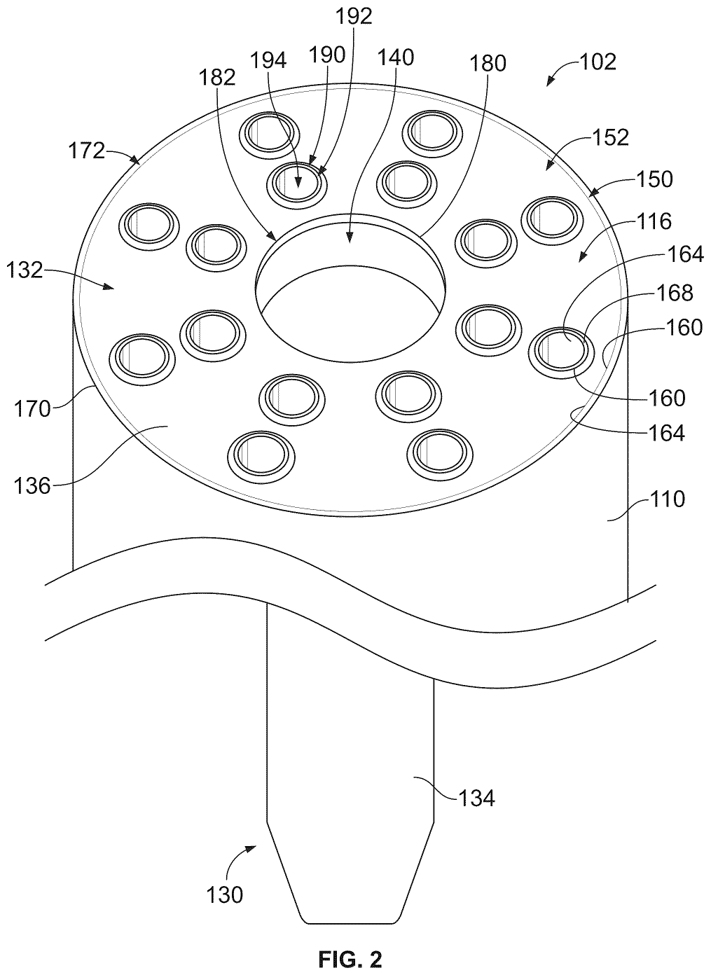

FIG. 2 is a perspective view of the conductor 102 in accordance with an exemplary embodiment. The conductor 102 includes the conductor body 110. The inhibitor encapsulation element 150 is provided at the connecting surface 116 of the conductor 102. The inhibitor encapsulation element 150 retains the corrosion inhibitor material at the connecting surface 116 to prevent corrosion (for example oxidation) of the connecting surface 116 to form a reliable, low resistance interface for mating with the mating conductor 104 (FIG. 1).

The conductor body 110 extends between a first end 130 and a second end 132. The first end 130 may be a mating end (which may be referred to hereinafter as mating end 130) configured to be mated to a mating component. The second end 132 may be a terminating end (which may be referred to hereinafter as terminating end 132) configured to be terminated to another component, such as the mating conductor 104.

In an exemplary embodiment, the mating end 130 includes a pin 134 configured to be mated with the mating component. For example, the pin 134 at the mating end 130 may be a charging pin configured to be connected to a charging connector. The charging pin may be a charging pin of an electric vehicle. For example, the charging pin may be located in a charging inlet assembly of an electric vehicle for charging the battery of the electric vehicle. The mating end 130 may have other mating contacts in alternative embodiments, such as a socket, a blade, a bus bar, a spring beam, or another type of mating contact for mating with the complementary mating component. In the illustrated embodiment, the pin 134 is generally cylindrical extending along a longitudinal axis of the conductor body 110. However, the pin 134 may have other shapes in alternative embodiments.

In an exemplary embodiment, the terminating end 132 includes a pad 136 configured to be mated to the mating conductor 104. In the illustrated embodiment, the pad 136 is located at the top of the conductor body 110. The pad 136 may include a generally planar connecting surface 116. In the illustrated embodiment, the terminating end 132 of the conductor body 110 is generally cylindrical. However, the terminating end 132 may have other shapes in alternative embodiments. In an exemplary embodiment, the inhibitor encapsulation element 150 is located at the terminating end 132. For example, the blocking walls 160 extends from the pad 136 to encapsulate or trap the corrosion inhibitor material at the pad 136 to create a reliable, low resistance connecting surface 116.

In an exemplary embodiment, the conductor body 110 includes a bolt opening 140 therethrough configured to receive the bolt 106. In various embodiments, the bolt opening 140 may be a threaded bolt opening configured to threadably receive the bolt 106. The bolt opening 140 may be oriented perpendicular to the connecting surface 116. The bolt opening 140 may be centered in the pad 136. For example, the bolt opening 140 may be centered along a longitudinal axis of the conductor body 110. Other locations are possible in alternative embodiments.

The inhibitor encapsulation element 150 is located at the connecting surface 116, such as along the pad 136 at the terminating end 132. The inhibitor encapsulation element 150 includes a plurality of the blocking walls 160 forming corresponding inhibitor wells 152. The inhibitor wells 152 are configured to receive the corrosion inhibitor material. The blocking walls 160 encapsulate or trap the corrosion inhibitor material within the corresponding inhibitor wells 152 to contain the corrosion inhibitor material at a predetermined area (for example, the mating area configured to be mated to the mating conductor 104).

In an exemplary embodiment, the inhibitor encapsulation element 150 includes an outer blocking wall 170 forming an outer ring 172. The outer ring 172 defines a mating area configured to be mated to the mating conductor 104. In an exemplary embodiment, the outer ring 172 surrounds a perimeter of the connecting surface 116. The outer ring 172 provides an outward boundary of the inhibitor encapsulation element 150. For example, the inhibitor well 152 is located inward of the interior surface 164 of the outer blocking wall 170. The interior surface 164 of the outer blocking wall 170 is configured to contain the corrosion inhibitor material within the inhibitor well 152. The outer blocking wall 170 contains the corrosion inhibitor material from flowing out of the mating area during assembly, such as during tightening of the bolt 106. Optionally, the outer ring 172 may be located at the outer periphery of the terminating end 132. In the illustrated embodiment, the outer ring 172 is circular. However, the outer ring 172 may have other shapes in alternative embodiments, including linear and/or angular shapes. In an exemplary embodiment, the outer blocking wall 170 is continuous around the perimeter of the connecting surface 116. For example, the outer blocking wall 170 forms a complete, continuous outer ring 172 without any gaps or discontinuities. However, in alternative embodiments, the outer blocking wall 170 may be discontinuous having gaps or openings to create a non-continuous outer ring 172.

In an exemplary embodiment, the inhibitor encapsulation element 150 includes an inner blocking wall 180 forming an inner ring 182. The inner ring 182 is located within the mating area defined by the outer ring 172 and is configured to be mated to the mating conductor 104. In an exemplary embodiment, the inner ring 182 surrounds a perimeter of the bolt opening 140. The inner ring 182 provides an inward boundary of the inhibitor encapsulation element 150. For example, the inhibitor well 152 is defined between the outer ring 172 in the inner ring 182. The corrosion inhibitor material is configured to be contained between the outer ring 172 in the inner ring 182. In the illustrated embodiment, the inhibitor well 152 has an annular shape surrounding the bolt opening 140. The inhibitor well 152 may have other shapes in alternative embodiments. The inner ring 182 to make contain the corrosion inhibitor material from flowing into the bolt opening 140. In the illustrated embodiment, the inner ring 182 is circular. However, the inner ring 182 may have other shapes in alternative embodiments, including linear and/or angular shapes. In an exemplary embodiment, the inner blocking wall 180 is continuous around the perimeter of the bolt opening 140. For example, the inner blocking wall 180 forms a complete, continuous inner ring 182 without any gaps or discontinuities. However, in alternative embodiments, the inner blocking wall 180 may be discontinuous having gaps or openings to create a non-continuous inner ring 182.

In an exemplary embodiment, the inhibitor encapsulation element 150 includes a nested blocking walls 190 forming nested rings 192. The nested rings 192 are nested within the mating area. For example, the nested rings 192 are located interior of the outer ring 172. The nested rings 192 are located between the outer blocking wall 170 and the inner blocking wall 180 and/or the bolt opening 140. Each nested ring 192 defines a mating area configured to be mated to the mating conductor 104. Each nested ring 192 defines the corresponding nested inhibitor well 194 that receives the corrosion inhibitor material therein. The nested ring 192 may have a conical shape formed by the protruding rib protruding from the connecting surface 116 to stand proud of the connecting surface 116, such as to form a mating feature configured to be mated to the mating conductor 104. The nested ring 192 provides an outward boundary for the corresponding nested inhibitor well 194. In various embodiments, the inhibitor well 194 may be formed as a depression extending inward into the conductor body 110, such as extending below the connecting surface 116.

The nested ring 192 may separate the corrosion inhibitor material located within the nested inhibitor well 194 from the corrosion inhibitor material located within the larger inhibitor well 152 defined by the outer ring 172. The nested blocking wall 190 contains the corrosion inhibitor material from flowing out of the nested inhibitor well 194 during assembly, such as during tightening of the bolt 106 to ensure that the corrosion inhibitor material is located at the mating interface defined by the outer edge 168 of the nested blocking wall 190, which is configured to mate with the mating conductor 104.

In an exemplary embodiment, the mating interface of the outer edge 168 is configured to cut or breakthrough any oxide layers on the mating conductor 104 during mating through a wiping action. The wiping action exposes the base metal material of the mating conductor 104 to form a low resistance electrical connection between the conductor 102 and the mating conductor 104.

In the illustrated embodiment, the nested ring 192 is circular. However, the nested ring 192 may have other shapes in alternative embodiments, including linear and/or angular shapes. In an exemplary embodiment, the nested blocking wall 190 is continuous around the perimeter of the connecting surface 116. For example, the nested blocking wall 190 forms a complete, continuous nested ring 192 without any gaps or discontinuities. However, in alternative embodiments, the nested blocking wall 190 may be discontinuous having gaps or openings to create a non-continuous nested ring 192.

Any number of the nested blocking walls 190 forming the nested rings 192 may be provided depending on the particular application. The nested rings 192 are spaced apart from each other. The nested rings 192 may be located throughout the connecting surface 116, such as to provide multiple points of contact to the mating conductor 104. The pattern of the nested rings 192 may depend on the size and shape of the available space within the mating area. In the illustrated embodiment, the nested rings 192 are arranged in concentric rings, such as an inner band and an outer band of the nested rings 192. The bands of the nested rings 192 may have the same number of nested rings 192 or may have different numbers of the nested rings 192. Greater or fewer bands of the nested rings 192 may be provided in alternative embodiments. Other patterns are possible in alternative embodiments.

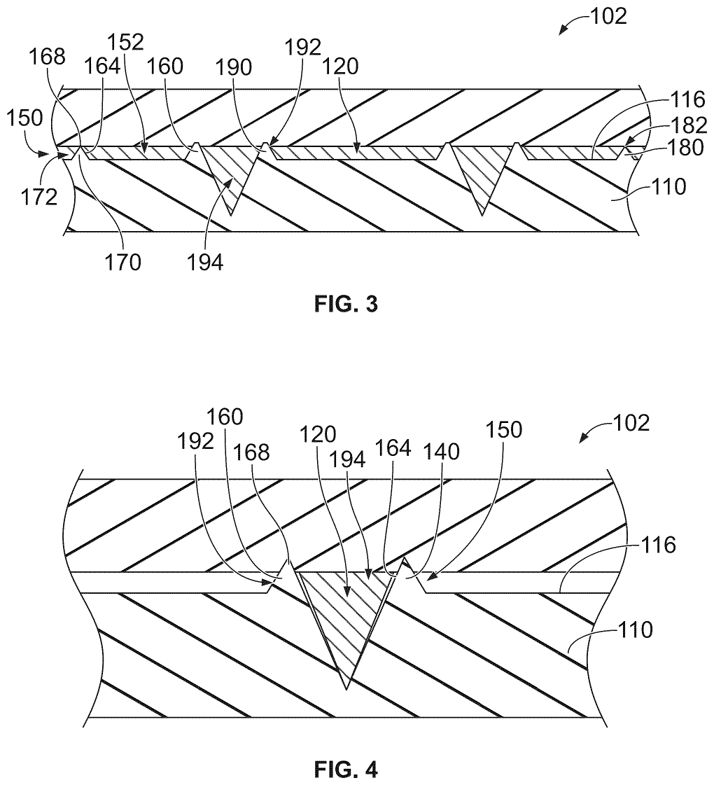

FIG. 3 is a cross-sectional view of the conductor 102 showing a portion of the inhibitor encapsulation element 150 in accordance with an exemplary embodiment. FIG. 4 is a cross-sectional view of the conductor 102 showing a portion of the inhibitor encapsulation element 150 in accordance with an exemplary embodiment. FIG. 3 shows the outer blocking wall 170 (and outer ring 172), the inner blocking wall 180 (and inner ring 182), and a pair of the nested blocking walls 190 (and nested rings 192). FIG. 4 is an enlarged view of one of the nested blocking walls 190 and the corresponding nested ring 192.

The inhibitor well 152 receives the corrosion inhibitor material 120. The blocking walls 160 encapsulate or trap the corrosion inhibitor material 120 within the corresponding inhibitor well 152 to contain the corrosion inhibitor material 120 at the mating area configured to be mated to the mating conductor 104. In an exemplary embodiment, the inhibitor well 152 is defined in the space between the outer blocking wall 170 and the inner blocking wall 180. The nested wells 194 are defined by the nested blocking walls 190 and corresponding nested rings 192. The nested wells 194 are located in the larger inhibitor well 152 defined between the outer blocking wall 170 and the inner blocking wall 180.

The outer ring 172 provides an outward boundary of the inhibitor encapsulation element 150 and the inner ring 182 provides an inward boundary of the inhibitor encapsulation element 150. For example, the inhibitor well 152 is located between the interior surfaces 164. The interior surfaces 164 are configured to contain the corrosion inhibitor material within the inhibitor well 152. The blocking walls 170, 180 contains the corrosion inhibitor material from flowing out of the mating area during assembly, such as during tightening of the bolt 106. The heights of the blocking walls 170, 180 at the distal edges 168 define the depth of the inhibitor well 152 above the connecting surface 116.

The nested rings 192 are nested within the mating area. The nested rings 192 are located between the outer blocking wall 170 and the inner blocking wall 180. Each nested ring 192 defines a mating area configured to be mated to the mating conductor 104. In an exemplary embodiment, the distal edges 168 are configured to be directly mated to the mating conductor 104. In an exemplary embodiment, the mating interface of the distal edge 168 is configured to cut or breakthrough any oxide layers on the mating conductor 104 during mating through a wiping action. The wiping action exposes the base metal material of the mating conductor 104 to form a low resistance electrical connection between the conductor 102 and the mating conductor 104.

Each nested ring 192 defines the corresponding nested inhibitor well 194 that receives the corrosion inhibitor material therein. The nested ring 192 provides an outward boundary for the corresponding nested inhibitor well 194. The nested ring 192 separates the corrosion inhibitor material located within the nested inhibitor well 194 from the corrosion inhibitor material located within the larger inhibitor well 152. The nested blocking wall 190 contains the corrosion inhibitor material from flowing out of the nested inhibitor well 194 during assembly, such as during tightening of the bolt 106 to ensure that the corrosion inhibitor material is located at the mating interface with the mating conductor 104. The heights of the nested blocking walls 190 at the distal edges 168 may be greater than the heights of the blocking walls 170, 180 to ensure that the nested rings 192 interface with the mating conductor 104 to define multiple points of contact between the conductor 102 and the mating conductor 104. In various embodiments, the inhibitor wells 194 are defined by depressions that extend inward into the conductor body 110, such as below the connecting surface 116. The inhibitor wells 194 may extend to a depth greater than the depth of the inhibitor well 152 above the connecting surface 116, such as to contain a greater amount of the corrosion inhibitor material.

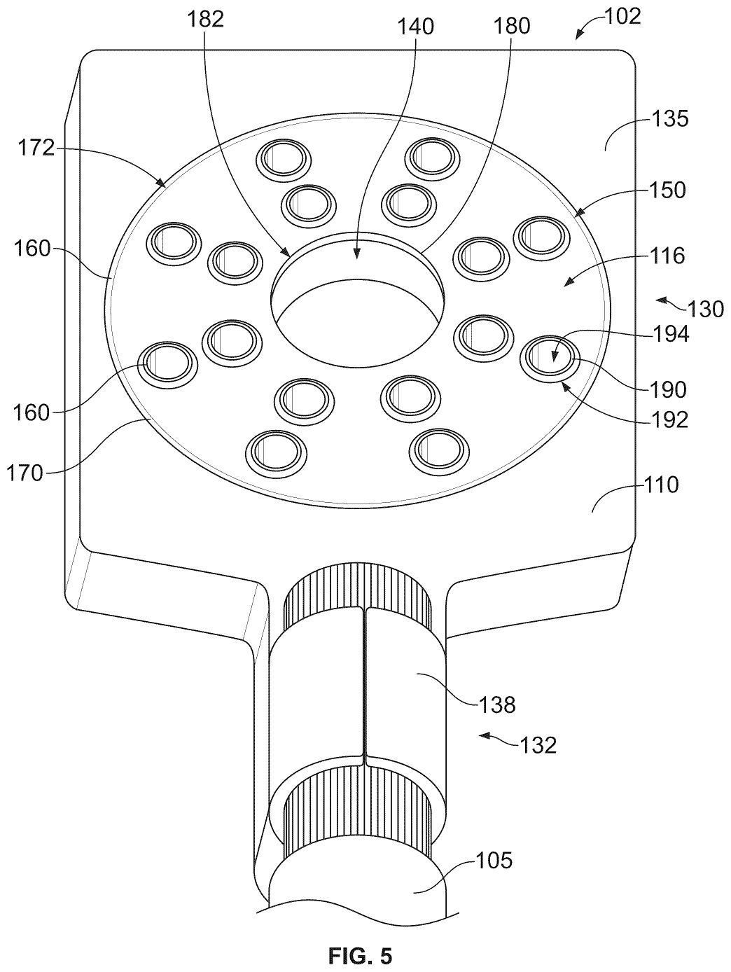

FIG. 5 is a perspective view of the conductor 102 in accordance with an exemplary embodiment. The conductor 102 has a different shape in the embodiment shown in FIG. 5 than the embodiment shown in FIG. 2 but like components are identified with like reference numerals. The conductor 102 includes the conductor body 110. The inhibitor encapsulation element 150 is provided at the connecting surface 116 of the conductor 102. The inhibitor encapsulation element 150 retains the corrosion inhibitor material at the connecting surface 116 to prevent corrosion (for example oxidation) of the connecting surface 116 to form a reliable, low resistance interface for mating with the mating conductor 104 (FIG. 1).

The conductor body 110 extends between the first end 130 and the second end 132. In an exemplary embodiment, the conductor body 110 includes a bolt opening 140 therethrough configured to receive the bolt 106. The first end 130 is a mating end (which may be referred to hereinafter as mating end 130) configured to be mated to a mating component. For example, the mating end 130 may be mated to a terminating end of a mating conductor, such as the terminating end 132 of the embodiment shown in FIG. 2. The second end 132 is a terminating end (which may be referred to hereinafter as terminating end 132) configured to be terminated to another component, such as a power cable 105. The power cable may be routed to another component, such as a battery system or other electrical component. In an exemplary embodiment, the terminating end 132 includes a crimp barrel 138 configured to be mated to the power cable 105. In alternative embodiments, the terminating end may include a weld pad rather than the crimp barrel 138 for terminating to the end of the power cable 105.

In other various embodiments, rather than being terminated to a power cable 105, the conductor 102 may be a busbar having the second end 132, remote from the first end 130, configured to be directly connected to another electrical component, such as a battery system or other electrical component. In various embodiments, the conductor body 110 of the busbar has the mating end 130 and the terminating end 132 both configured to be directly connected to respective electrical components. Both the mating end 130 and the terminating end 132 may include inhibitor encapsulation element 150. The mating end 130 and/or the terminating end 132 of the busbar may include bolt openings for bolted connections to the electrical components.

In an exemplary embodiment, the mating end 130 includes a pad 135 configured to be mated with the mating component. For example, the pad 135 at the mating end 130 may be coupled to a charging pin, such as to the top end of the charging pin shown in FIG. 2. The charging pad may electrically connect the power cable to the charging pin for connecting to a battery of an electric vehicle. The mating end 130 may have other types of mating contacts in alternative embodiments. In the illustrated embodiment, the pad 135 is generally planar and rectangular. However, the pad 135 may have other shapes in alternative embodiments.

In an exemplary embodiment, the inhibitor encapsulation element 150 is located at the mating end 132. For example, the blocking walls 160 extends from the pad 135 to encapsulate or trap the corrosion inhibitor material at the pad 135 to create a reliable, low resistance connecting surface 116. The inhibitor encapsulation element 150 may be similar to the inhibitor encapsulation element 150 shown in FIG. 2. For example, the inhibitor encapsulation element 150 may include the outer blocking wall 170 (and outer ring 172), and/or the inner blocking wall 180 (and inner ring 182), and /r the nested blocking walls 190 (and nested rings 192).

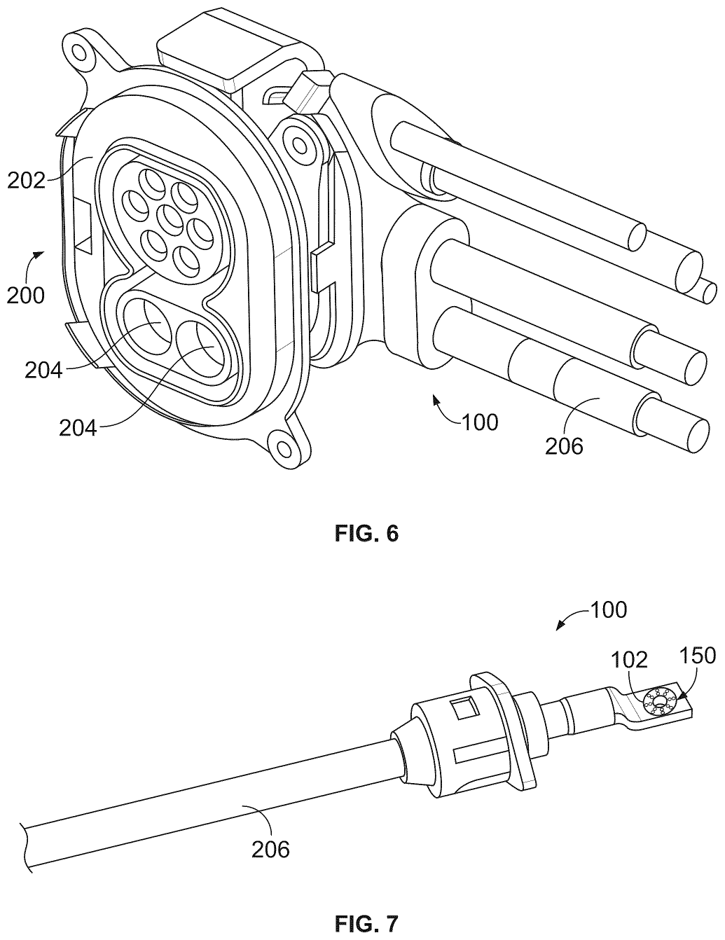

FIG. 6 is a perspective view of a charging inlet assembly 200 in accordance with an exemplary embodiment that incorporates the electrical connector 100. FIG. 7 is a perspective view of the electrical connector 100 in accordance with an exemplary embodiment for use in the charging inlet assembly 200. The electrical connector 100 may be used in other types of assemblies and is not limited to use in a charging inlet assembly 200. The charging inlet assembly 200 may be used in an electric vehicle as a charging inlet for charging the battery of the electric vehicle.

The charging inlet assembly 200 includes a housing 202 that holds charging terminals 204. The charging terminals 204 configured to be electrically connected to power cables 206 extending from the charging inlet assembly 200. The power cable 206 is part of the electrical connector 100 and is terminated to an end of the conductor 102. The conductor 102 is configured to be electrically connected to the charging terminal 204 by a bolted connection. The conductor 102 may include the inhibitor encapsulation element 150 (such as shown in FIG. 5). In other various embodiments, the terminating end of the charging terminal 204 may include the inhibitor encapsulation element 150 (such as shown in FIG. 2).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. A conductor for an electrical connector comprising:
a conductor body extending between a mating end and a terminating end, the conductor body including a connecting surface at one or more of the mating end or the terminating end;
an inhibitor encapsulation element including a blocking wall extending from the connecting surface, the blocking wall forming an inhibitor well along the mating surface configured to be filled with corrosion inhibitor material, the blocking wall configured to capture the corrosion inhibitor material in the inhibitor well on the mating surface.

2. The conductor of claim 1, wherein the conductor body includes a bolt opening configured to receive a bolt for coupling the conductor body to a mating conductor by a bolted connection.

3. The conductor of claim 2, wherein the blocking wall and the inhibitor well surround the bolt opening.

4. The conductor of claim 1, wherein the blocking wall forms a ring completely surrounding the inhibitor well to retain the corrosion inhibitor material in the inhibitor well.

5. The conductor of claim 1, wherein the blocking wall includes a rib extending to an edge, the edge configured to be coupled to a mating conductor.

6. The conductor of claim 1, wherein the blocking wall is an outer blocking wall forming an outer ring defining a mating area configured to be mated to a mating conductor.

7. The conductor of claim 6, wherein the inhibitor encapsulation element includes a nested blocking wall forming a nested ring embedded within the mating area, the nested blocking wall forming a nested inhibitor well configured to be filled with the corrosion inhibitor material, the nested blocking wall configured to capture the corrosion inhibitor material in the nested inhibitor well.

8. The conductor of claim 7, wherein the nested blocking wall is one of a plurality of nested blocking walls forming corresponding nested inhibitor wells configured to be filled with the corrosion inhibitor material, the nested blocking walls being spaced apart from each other within the mating area defined by the outer ring.

9. The conductor of claim 7, wherein the inhibitor well has a first depth and the nested inhibitor well has a second depth deeper than the first depth.

10. The conductor of claim 7, wherein the outer blocking wall has a first height from the connecting surface, the nested blocking wall having a second height from the connecting surface different than the first height.

11. The conductor of claim 6, wherein the inhibitor encapsulation element includes an inner blocking wall forming an inner ring inside the outer ring, the inhibitor well is an annular well between the inner ring and the outer ring configured to be filled with the corrosion inhibitor material.

12. The conductor of claim 11, wherein the conductor body includes a bolt opening configured to receive a bolt for coupling the conductor body to a mating conductor by a bolted connection, the inner ring surrounding the bolt opening.

13. The conductor of claim 1, wherein the blocking wall is conical shaped.

14. The conductor of claim 1, wherein the conductor body includes a pin at the mating end.

15. The conductor of claim 1, wherein the conductor body includes one of a crimp barrel or a weld pad at the terminating end configured to be terminated to a power cable.

16. The conductor of claim 1, wherein the conductor body is manufactured from aluminum or an aluminum alloy or from copper or a copper alloy.

17. The conductor of claim 1, further comprising corrosion inhibitor material received in the inhibitor well.

18. The conductor of claim 1, wherein the conductor body is a busbar having the mating end and the terminating end both configured to be directly connected to respective electrical components.

19. A conductor for an electrical connector comprising:
a conductor body extending between a mating end and a terminating end, the conductor body including a mating surface at the mating end;
an inhibitor encapsulation element including blocking walls extending from the mating surface forming inhibitor wells along the mating surface, the blocking walls including an outer blocking wall forming an outer ring defining a mating area, the blocking walls including a nested blocking wall forming a nested ring embedded within the mating area and surrounded by the outer ring, the inhibitor wells configured to be filled with corrosion inhibitor material, the blocking walls configured to capture the corrosion inhibitor material in the corresponding inhibitor wells on the mating surface.

20. The conductor of claim 19, wherein outer ring forms a continuous perimeter around the inhibitor well formed by the outer ring, the nested ring forms a continuous perimeter around the inhibitor well formed by the nested ring.

21. An electrical connector comprising:
a power cable having an end; and
a conductor having a conductor body extending between a mating end and a terminating end, the terminating end terminated to the end of the power cable, the conductor body including a mating surface at the mating end, the conductor including an inhibitor encapsulation element including a blocking wall extending from the mating surface, the blocking wall forming an inhibitor well along the mating surface configured to be filled with corrosion inhibitor material, the blocking wall configured to capture the corrosion inhibitor material in the inhibitor well on the mating surface
